(19) United States
(12) Patent Application Publication
(10) Pub. No.: US 2003/0025227 A1
(43) Pub. Date: Feb. 6, 2003

(54) Reproduction of relief patterns

(75) Inventor: Stephen Daniell, Northampton, MA (US)

Correspondence Address: TESTA, HURWITZ & THIBEAULT, LLP, HIGH STREET TOWER, 125 HIGH STREET, BOSTON, MA, 02110, US

(73) Assignee: Zograph, LLC, Northampton, MA

(21) Appl. No.: 10/208,325

(22) Filed: Jul. 30, 2002

Related U.S. Application Data
(60) Provisional application No. 60/309,663, filed on Aug. 2, 2001.

(51) Int. Cl. B29D 11/00; B29C 33/40

(52) U.S. Cl. 264/2.5; 264/219

(57) ABSTRACT

A relief master is formed by assembly of previously molded, machined, or otherwise fabricated relief structures. The relief structures may be quite small and include a relief geometry, i.e., a topology of interest, and a positioning feature. The relief structures are mounted on a rigid (e.g., metal) substrate that includes a plurality of positioning features complementary to the positioning features in the relief structures. The relief master is assembled through selective application and positioning of the small-scale relief structures, and can then be used as a pattern for diverse surface replication processes, including the fabrication of durable metal mold faces for casting, embossing, compression molding, and injection molding of complex patterned surfaces.

### RELATED APPLICATION

This application claims the benefits of U.S. Provisional Application Serial No. 60/309,663, filed on Aug. 2, 2001, the entire disclosure of which is hereby incorporated by reference.

### FIELD OF THE INVENTION

The present invention relates to the fabrication and replication of devices having complex relief surfaces, and in particular to the manufacture of monolithic devices having repeated, small-scale features. Such devices include, for example, microooptical arrays, such as refractive microlens arrays.

### BACKGROUND OF THE INVENTION

Lens arrays can be assembled from a set of discrete lenses or lens systems. This process, however, is time-consuming and costly, especially as the number of components increases. Consequently, a great deal of effort has been directed toward the development of molds for the formation of monolithic arrays. These molds may be used for the cost-effective, repetitive production of a given design.

The replication of one or more generations of mold faces from an original surface, commonly by the electroforming of nickel on the master pattern, is well known. In electroforming, a metal shell is formed over the master pattern by electrodeposition in a plating bath, and is subsequently removed. The process accurately reproduces the master pattern without the shrinkage and distortion associated with other metal-forming techniques such as casting, stamping or drawing.

Nonetheless, certain types of patterned arrays remain difficult to originate. In particular, deep-relief refractive arrays, high-fill-factor arrays, and aspheric lens-array components have remained a challenge to form in a master. These design features are highly valued, yielding wide display angles, high optical efficiency, low distortion, and other desirable effects in both imaging and non-imaging optical applications.

The prior art includes diverse efforts at producing such surfaces. Etching processes have facilitated the parallel production of microlens array masters. A perforated mask on a substrate, if agitated during the isotropic etching operation on a homogeneous material, will produce a spherical cavity. However, the process is generally not suited to production of aspheric or high-fill-factor arrays. Anisotropic etching by reactive ion milling, in combination with grayscale masks, has produced microlens arrays. Although large numbers of subcomponents can be produced in parallel by anisotropic etching, optical-quality lenses with consistent sag heights greater than 25 μm are difficult to obtain.

Lens patterns have also been created by surface tension using positive or negative menisci that are solidified by a cooling or curing action. These processes, known diversely as polymer reflow, contactless embossing, mass transport, and droplet deposition, have been prone to inconsistencies over relatively large areas. Furthermore, each element ordinarily is physically isolated to avoid a breakdown of surface tension, thereby excluding high fill factors.

Because of the limits of these approaches, there remains ongoing interest in production methods in which the manufacture of microcomponent surfaces is subject to minimal variation across an array pattern. One technique traditionally used to circumvent process variables employs individual elements that have been prefabricated by a consistent and well-characterized method. These are then assembled into a compound master relief, which is itself used as a pattern to create duplicate forms.

To generate a simple compound master pattern, a set of polished glass or metal spheres can be arranged in a hexagonal lattice, cemented in place and used as an original pattern for a metal mold face; see, e.g., U.S. Pat. No. 3,365,524. However, such a pattern will typically exhibit optically ineffective interstices between the subcomponent spheres, limiting the obtainable fill factor. Furthermore, the lenses are hemispheres, which produce optical aberration.

Diamond-machining has recently been developed to a high degree of precision. U.S. Pat. No. 6,402,996, for example, proposes using a half-radius cutting member in a plunge operation. However, plunging a tool along the axis of rotation of the tool can be expected to leave an artifact at the center of the cavity, due to the lack of sufficient rotational velocity near the axis of the tool. Furthermore, in the mechanical tooling of large-area arrays, several practical problems have been encountered. First, as the process can take a period of days, power outages and operational errors that result in failures are common. Second, diamond tool wear tends to occur as a stepped rather than as a linear function. Large lens arrays therefore tend to have visibly distinct regions where the abrupt wear events occurred. Third, a single flawed cavity, due, for example, to a trapped burr, can result in the rejection of the entire array tooling.

In contrast, single-point diamond turning can manage tool feed rates and angles in such a manner that axial artifacts are not evident in the finished mold tooling. It is therefore often the method preferred for the production of lens mold cavities, and has also been used in the manufacture of microstructured arrays. Because of the slow operation of the tool, however, single-point turning is ordinarily limited in practice to the production of a relatively small number of repeated relief elements.

### DESCRIPTION OF THE INVENTION

### BRIEF SUMMARY OF THE INVENTION

The present invention facilitates convenient and rapid production of finely featured relief masters, which may themselves be used to create molds for mass production of structures corresponding to the original relief master. In accordance with the invention, a relief master is formed by assembly of previously molded, machined, or otherwise fabricated relief structures. The relief structures are typically quite small (on the scale of the smallest surface features to be reproduced) and include a relief geometry, i.e., a topology of interest, and a positioning feature. The relief structures are mounted on a rigid (e.g., metal) substrate that includes a plurality of positioning features complementary to the positioning features in the relief structures. For example, the relief-structure positioning features may be shafts, and the substrate positioning features may be holes that frictionally receive the shafts. The relief master is assembled through selective application and positioning of the small-scale relief structures—that is, the relief structures actually make up the desired surface pattern. The assembled master can then be used as a pattern for diverse surface replication processes, including the fabrication of durable metal mold faces for casting, embossing, compression molding, injection molding, and electroforming of complex patterned surfaces. An advantage of the invention is the ability to employ a rapid serial process both to produce the relief structures (e.g., injection molding) and to position them with respect to the substrate (e.g., by means of a robotic gantry). The use of finely featured but identical relief structures allows a structure to be fabricated ab initio only once (e.g., by single-point diamond turning), and thereafter reproduced cheaply. Assembly, rather than machining or other costly fabrication, facilitates efficient production of complex surfaces with microscopic features. (Notwithstanding the benefit of identical relief structures, it should be appreciated that not all such structures need be identical for a given application. In particular, structures having different relief and/or positioning feature geometries may be employed on a single substrate, and the benefits of the invention are retained to the extent that at least some structures of the same type are serially applied to the substrate and contribute to buildup of the desired surface.)

In accordance with a first aspect, therefore, the invention comprises a method of replicating a surface. In accordance with the method, a rigid substrate having positioning features and a plurality of relief structures, each having a relief geometry and a positioning feature complementary to the substrate positioning features, are provided. The feature elements are joined to the substrate by mating the substrate positioning features and the relief-structure positioning features, thereby forming a relief master, which is replicated.

In a second aspect, the invention comprises a relief master including a rigid substrate having positioning features and a plurality of identical relief structures. The relief structures have a relief geometry as well as a positioning feature complementary to the substrate positioning features. The relief structures are joined to the substrate and form a surface pattern by mating of the substrate positioning features and the relief-structure positioning features.

In particular embodiments of embodiment of the invention, relief structures are injection-molded in thermoplastic polymer, and then installed in a common metal substrate that has be prepared with a set of blind holes. Polymers with intrinsically low shrinkage and high thermal stability are preferred in order to minimize the risk of deflection or deformation at the temperatures utilized for their replication. These polymers also minimize arbitrary departures from net shape. Nevertheless, they desirably also exhibit the economical cycle times characteristic of conventional injection molding. Examples of polymers having relatively high melting points include polytetrafluoroethylene (PTFE) (e.g., the TEFLON polymer supplied by E.I. duPont de Nemours, Wilmington, Del.), polyetherimide (e.g., the ULTEM polymer supplied by GEHR Plastics, Inc., Boothwyn, Pa.) and polyamide-imides (e.g., the TORLON polymer supplied by Boedeker Plastics, Inc., Shiner, Tex.). Polymers such as these can often be compounded to include 20 to 40% mineral material, such as glass fiber, which can further improve dimensional stability. Liquid crystal polymers may also be employed.

As in the preparation of any precision mold, factors that affect the net shape of the surface of the final product should be anticipated as much as possible in the design process. For example, if the relief surface corresponds to a lens array, these factors may include compensation for shrinkage of the polymer preforms, surface offsets for the buildup of one or more metal coatings during the replication process, the thickness of release agents between generation of masters, mold coatings, compensation for shrinkage in the final molded lens array, and the buildup of optical coatings subsequent to the molding of the array. These factors are well known in the art of precision molding. Because each mold design and each thermoplastic material has unique properties, such compensatory geometric modifications have long been automated in the preparation of molded articles.

In practice, these automated compensatory changes are not fully predictive. Furthermore, the mold-development process and the production environment can impose variations on the originally envisioned processes. Strategies are available to address these variations. For example, in a particular embodiment described herein, two functionally related, mechanically complementary surfaces are generated. The first pattern is subjected to an odd number of replications, while the second pattern is subjected to an even number. In the production of parts with functionally related reliefs, such as two-sided or layered optical systems, this procedure minimizes the accumulation of surface-offset errors that can cause poor mechanical fitting or lowered optical performance. When the number of replicas is equal, by contrast, the original patterns must both have the same relief orientation with respect to the final part. Therefore, offset errors will tend to be either both additive, or both subtractive, and are commonly expressed as a positive or negative conformal dimensional departure from the anticipated net shape.

Thus, two masters may be, subsequent to their assembly, replicated through a similar process. The processes, however, are repeated and staggered by a generation. Therefore, when a conformal error is positive in one case, it will typically be negative in the other. Thus, the introduced error will be largely self-compensating, and an offset error of a given thickness will have a less detrimental effect on optical performance and on mechanical functions such as fitting and alignment.

The principles of the invention may be implemented in diverse applications and in various embodiments. In one embodiment, molded pins, each including the preform of an optical aperture, are individually mounted in a metal substrate that has been provided with a plurality of holes therein. Both the pin and the hole are slightly tapered, so that a sufficiently frictional fit is obtained to retain the pin in the substrate without an adhesive. In another embodiment, the shafts of the molded pins and the holes in the substrate are of essentially cylindrical geometry, and are assembled with little insertion force by the management of the relative thermal properties of the substrate and the molded pins. In still another embodiment, the cross-sections of the shaft and the hole differ in contour over part of the perimeter so that an exit path is provided for entrapped fluid such as air. The complementary mating features on the relief structure and its compatibly formed hole may be devised so that rotation is prohibited, and to physically encourage the relief structure to attain a particular orientation in the substrate.

An undercut may be provided in the relief structure so that microdebris produced by installation of the relief structure in the substrate does not interfere with the precise seating of the relief structure thereagainst. Each relief structure may also carry preformed surfaces for several microfeatures, so that the number of relief structures required to produce given pattern is reduced.

Elements which may be included in a micro-optical system include refractive lenses, fresnel lenses, prisms, reflectors, beamsplitters, diffraction gratings, diffractive lenses, hybrid diffractive/refractive surfaces, diffusers, and optical or mechanical alignment structures. Lens relief structures may be individually formed or installed the substrate, or may be clustered on the relief structure. Relief structures can be provided with polygonal perimeters so that the relief structures can be made to tile with high efficiency. The present invention may be employed to produce complex surfaces that are not based wholly on geometries of rotation. Relief structures may include a plurality of features arranged in a pattern. The features may be identical, or may be varied within each relief structure.

### BRIEF DESCRIPTION OF THE DRAWINGS

The foregoing discussion will be understood more readily from the following detailed description of the invention, when taken in conjunction with the accompanying drawings, in which:

FIG. 1 is a perspective view of a relief master assembled in accordance with the present invention;

FIGS. 2 and 3 are side elevations of relief structures useful for producing lens arrays;

FIGS. 4A and 4B illustrate formation of a two-layer lens array from components fabricated in accordance with the invention;

FIG. 5 illustrates placement of a prismatic relief structure; and

FIG. 6 illustrates a bilevel device formed from a relief master assembled in accordance with FIG. 5.

### DETAILED DESCRIPTION OF THE PREFERRED EMBODIMENTS

The ensuing example details production of a surface pattern for forming an optical array. It should be understood, however, that the example is for illustrative purposes only. The invention is suited to production of any monolithic devices having repeated, small-scale features, e.g., microtiter plates, microfluidic networks, bioassay systems, inkjet print nozzles, antenna structures, or mechanical sensing elements. Moreover, the character of the relief structures is relatively specific. Each relief structure is a pin that is rivet-like in form, having a shaft and a head, and is preferably produced by injection molding. The relief structures may have slightly tapered shafts and a head including an optical surface geometry and a mechanical surface geometry. (As the mold pins serve only as patterns, they need not be transparent to optical radiation. Occluding material such as mineral fibers may therefore be included in the polymer compound without compromising the optical quality of the surfaces, provided process temperatures are maintained at a level sufficient to ensure flow and avoid clumping of the mineral fill.)

Again, it should be understood that the positioning features of the invention are not limited to holes and shafts; any mating features that can serve to reliably join the relief structures to the substrate with positional integrity, such as [???][stops, brackets, ridges, wedges, polygonal or stellate features, grids, tines, or bayonet mounts], can be used to advantage.

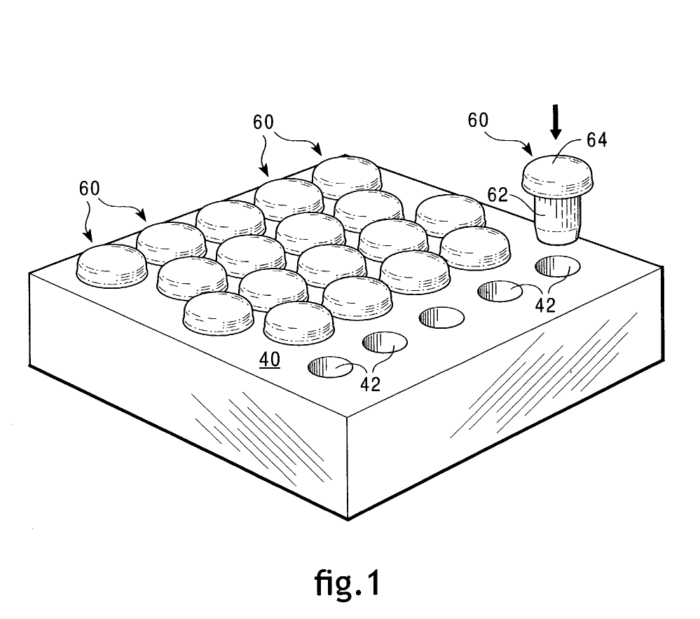

Use of the principles of the invention to create a relief master for a lens array is illustrated in FIG. 1. As shown therein, a substrate 40 has a plurality of inverse mating features 42. The mating features 42 can each receive a relief structure 60, in particular a positioning feature 62 thereof. The relief structures 60 are frictionally held in place in the mating features 42 of the substrate 40. In one embodiment, the thickness of substrate 40 exceeds the lengths of the positioning features 62, and the mating features 42 are blind holes. In other embodiments, the mating features 42 are through-holes. Once the relief structures 62 are situated in any or all of the mating features 42, the compound surface may be produced, in reverse, by electroforming.

The electroformed replica may be installed in a conventional molding machine and reproduced in a suitable final mold material. To form a lens array, the final mold material may be an optically transparent thermoplastic. The optical characteristics of the lens elements correspond to the relief geometries of the head portions 64 of structures 60.

The substrate 40 can be fabricated from any suitable rigid material, e.g., metal or glass. Mating features 42 may be created, for example, by the mechanical micromilling of a prepared metal blank. A suitable prepared metal blank can be made, e.g., by the electrodeposition of copper to a thickness greater than the depths of mating features 42 upon a relatively thick 0-1 tool steel plate. For arrays larger in area than a few inches, the steel plate may have a thickness of 25 mm or more to ensure planarity of the pattern substrate and the subsequent generational replicas. For patterns having final feature pitches of 0.5 mm to 2.0 mm, an electrodeposition of 2.5 mm of copper is generally effective. Copper is preferably applied symmetrically to both faces of the plate. This symmetry ensures a balancing of dynamic forces in the substrate 40. It also permits a high-precision reference surface to be milled into the copper on one side. The milling operation may be performed, for example, using a diamond fly-cutting tool. The milled first side of the metal blank may be held fixedly against the reference surface of the milling machine, typically by vacuum clamping, while a second, parallel face is similarly milled.

Serial milling operations may be performed on a CAD-controlled translational stage. Mechanical tools for forming round tapered holes may include bits, end-mills, fly-cutters or broaches. Diamond fly-cutting is usually used for the preparation of flat surfaces, while plunging operations such as hole-boring may use dedicated diamond tooling, e.g., a single-crystal diamond boring tool with a small radius and relief angle at the tool end. Blind-hole aspect ratios in accordance herewith typically range from 1:2 to 2:1. In particular, hole width-to-depth factors of 0.8 to 1.2 have been found to be effective, as deeper holes can risk tool breakage, and shallower holes provide poorer positioning and retention of the relief structures 60. The incursion of the tool into the hole may be continuous, stepped, or otherwise varying.

In one embodiment, the slope of a sidewall departs from perpendicularity by approximately 1°. The substrate 40 can have any number of mating features. By way of example, an 8×8 array of holes, arranged in offset columns, is shown in FIG. 1. The pitches of the holes 42 need not be identical to the pitches of the desired final locations of relief structures 60, and commonly depart from these final measurements in order to compensate for thermal shrinkage, flow-induced asymmetries, and subsequent coating.

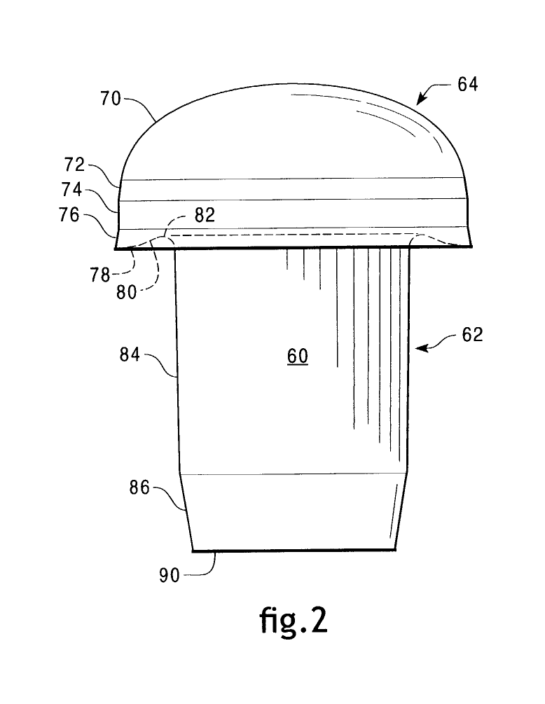

A relief structure 60 exemplified in the form of an aspheric, rotationally symmetrical mold pin is shown in FIG. 2. The mold pin 60 in this case is designed for the production of an array of lenses having a concave, aspheric geometry. The head of the mold pin 60 includes a curved contour 70 serving as a precursor to an eventual optical aperture, five bevels 72, 74, 76, 78, 80, and a radiused fillet 82. This indentation accommodates debris that might otherwise interfere with flush mating. The shaft 62 of the mold pin 60 includes two tapers 84, 86 and a round end face 90. Bevels and tapers in the illustrated embodiment are preferably conic in geometry. For purposes of description, bevels and tapers may be defined by their angular departure from the rotational axis of the mold pin geometry.

In the illustrated embodiment, first bevel 72 has a 150 slope, second bevel 74 a 3° slope, and third bevel 76 a 15° slope. The fourth and fifth bevels 78, 80, which occupy the underside of head portion 64, may be better understood by their departure from the primary plane of the substrate to which the relief structure 60 will be affixed. Bevel 78 is canted at 2° to the surface and bevel 80 at 25°. The first taper 84 of shaft 62 has a 1° slope, while the guide taper 86 has an angle of 15° to the axis of the mold pin. The shaft 62 and head portion 64 are made geometrically continuous by fillet 82. A negative mold cavity may be fabricated to reproduce the relief structure 60, typically by injection-molding.

A second embodiment of a relief structure, indicated generally at 60′ in FIG. 3, differs from the aspheric mold pin 60 only in the geometry of the optical aperture precursor surface 70′, and in the tolerancing for fit and shrinkage.

In the illustrated embodiment, a first bevel 72′ has a 15° slope, second bevel 74′ a 3° slope, third bevel 76′ a 15° slope. Bevel 78′ is canted at 2° to the substrate surface and bevel 80′ at 25°. The first taper 84′ of shaft 62′ has a 1° slope, while the guide taper 86′ has an angle of 15° to the axis of the mold pin. The shaft 62′ and head portion 64′ are made geometrically continuous by fillet 82′.

These relief structures 60, 60′, having maximum diameters of, for example, 1.44 mm and 1.41 mm, respectively, may be molded using micromolding equipment and a diamond-turned concentric taper lock to ensure centration of the two mold halves. In one embodiment, the shaft diameter of the relief structure is set at a dimension of 0.905 mm ±2 μm. While the anticipated function of the exemplary embodiments is purely refractive, patterns for refractive/diffractive hybrids can readily be produced by single-point diamond turning. Substrates composed of copper electroformed on tool steel have been provided with 20,000 holes 42 each. Holes in this exemplary embodiment are 0.950 mm deep and 0.900 mm wide. Variation in the hole diameter is desirably constrained to +2 μm. In this case, the shaft 62 is slightly oversized, so the relief structure 62 may be friction-fitted into the holes 42 or thermally manipulated to provide low-resistance installation.

Relief structures 60 may be installed in the substrate 40 either with or without a bonding agent. Where a bonding agent is used, a thin film thereof may be deposited on substrate 40 by aerosol application, spin-coating, vacuum deposition, or by roller or pad transfer. Thermosetting acrylates, for example, may be used in such an application. In cases where the polymer used to mold the relief structures 60 is known to be soluble in an organic solvent, a bond free of additional solids can be obtained by momentarily dipping part of the molded relief structure in the solvent, installing the relief structure in a complementary recess, and allowing the solvent to soften the surface of the relief structure so that contact areas develop a surface bond.

Alternatively, the thermal and mechanical properties of the materials can be exploited to promote a primarily frictional bond. For example, a metal substrate 40 and polymer relief structures 60 can have significantly different coefficients of expansion. Typically, it will be advantageous to have a frictional bond effective at room temperature so that parts do not loosen under normal handling. Given tooling and molding tolerances of ±2 μm and a 0.9 mm diameter of shaft 62, the size of the shaft relative to the hole is reduced by approximately 1% to effectuate zero-insertion-force installation of the relief structures 60. This dimensional disparity can be momentarily induced by differential temperature-dependent expansion (or contraction) of the relief structures and the substrate. For example, both relief structures 60 and substrate 40 may be chilled; the shaft of a relief structure, having the higher coefficient of thermal expansion, is thereby momentarily undersized relative to the holes 42. Another way a disparity may be introduced is to maintain the substrate 40 at a relatively higher temperature than the relief structures 60 prior to assembly.

A conventional, automated pick-and-place insertion device may be employed to remove a relief structure (e.g., as illustrated, a polymer mold pin including an optical surface contour and a set of bevels) from a tray. The selected relief structure is relocated to a predetermined x,y position above a relief feature of substrate 40, in this case a round tapered hole 42. The insertion device is then advanced along the z-axis with sufficient force that the shaft of the mold pin mechanically engages with the sidewall of the tapered hole. Insertion is halted by contact between the circular rim defined on the underside of the head portion 64, i.e., the flat annular surface extending from the edge of the head portion 64 to bevel 78 (see FIG. 2). The inserted mold pin is retained against the substrate by both friction and by the suction provided by the partially evacuated hole. The insertion device is then retracted and returned to the tray. The process is repeated for the next desired location. Once all targeted sites are occupied, the pattern assembly is complete. It should be noted that different relief structures (e.g., mold pins having aspheric surfaces as well as mold pins having spherical surfaces) may be introduced in different holes 42 if optical variability across the lens array is called for.

If an adhesive has been used on the substrate surface, curing can be accelerated once all parts are installed in the substrate. While the use of an adhesive is by no means essential, it can provide additional gasketing of the relief structures where the rims are seated against the substrate. Gasketing can discourage the formation of metal flashing underneath relief structures during subsequent electroforming. Gasketing can also be effected by the deposition of a conformal coating over the assembled pattern. The conformal coating may be organic, metallic, or a combination. Examples of suitable metals include gold, silver copper, aluminum and nickel.

The present invention may be conveniently employed to create interfitting lens arrays as described in copending application Ser. No. 09/811,298, filed Mar. 17, 2001 and entitled “LENS ARRAYS,” the entire disclosure of which is hereby incorporated by reference. As described therein, a two-piece lens array comprises first and second interfitting members. The first member may have lens elements with spherical convex optical surfaces, while the second member may have lens elements with aspheric concave optical surfaces. The structure of the complementary lens arrays facilitate their joinder such that the lens elements of the first member optically align with the lens elements of the second member. To create the second array member, the preceding pick-and-place insertion operation is repeated for a commensurate arrangement of locations, this time using the spherical mold pins shown in FIG. 3. Since the final optical surfaces of the second member are to be convex, only a single replica is drawn from the assembled array precursor. Once the requisite mold inserts are formed and mounted, the composite geometry of the intermediate master can be replicated in a monolithic part from thermoplastic material. Common thermoplastic polymeric materials that are transparent to visible light include acrylic, polycarbonate, and styrene.

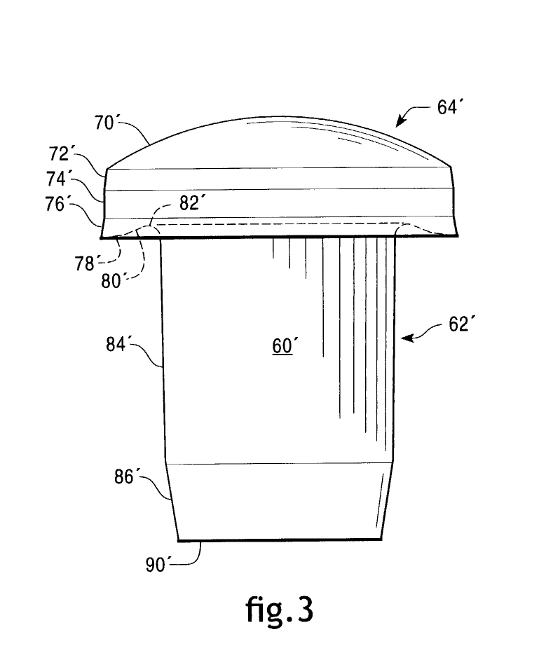

An inverse nickel mold may be drawn from each of the assembled patterns by a relatively heavy deposition of nickel upon the finished assembly. As noted above, in the case of the second member, a subsequent replica is drawn from the inverse nickel master to produce the convex shapes needed to yield the desired final concave aspheric lens apertures. The resulting interfitting members 100, 110 are shown in FIGS. 4A and 4B. The second member 110 includes an array of spherical convex optical surfaces that align with the aspheric convex surfaces 115 of the first member 100. The replicated mold-pin arrangement provides complementary mating features 120, 122 that encourage the alignment of the two lens-array surfaces so that they may easily be mechanically engaged. The engaged members 100, 110 can be advanced to form a frictional bond that is highly resistant to accidental separation. Assembly by this method also separates the optical apertures from one another by a distance that allows an optical space 125 to be established and reliably maintained. This mechanical interfacing may be extended to any number of stacked layers, and may include filling of voids by adhesives of various refractive indices. Adhesive layers so formed may also act as refractive lens components.

Electroforming from nonconductive patterns may be achieved by rendering the pattern conductive, e.g., by vacuum deposition of a thin (˜1 μm) metalic layer upon the nonconductive material. Vacuum deposition can also be to build up a seamless surface on the substrate for subsequent replication. Metals that may be vacuum deposited in anticipation of electroforming include gold, silver, aluminum, and titanium compositions such as titanium carbonitride (TiCN).

In electroforming, metal is electrolytically deposited to a predetermined thickness on the assembled master pattern. The deposited metal is then parted from the original assembled pattern, leaving an inverse replica thereof. The metal replica may be used directly as a mold insert to produce monolithic parts in a thermoplastic material, as a form for casting UV-activated or thermoset resins, or as an intermediate master for subsequent generations of mold tooling. The temperature of the electrolytic bath is typically in the vicinity of 55° C.

Suitable metal replicas may also be formed metal vapor deposition. However, because metal in vapor form, typically nickel, is deposited at a much higher temperature than that typically maintained in an electroforming bath, master patterns should be stable at a higher continuous operating temperature than prevail in electroforming. Polymers such as polyetherimide, fluoropolymers, and liquid crystal polymers are known to have deflection temperatures above those typically specified for nickel vapor deposition. When metal vapor deposition is used in the invention, it may be desirable to obtain a heat-resistant intermediate pattern from the original compound master when the compound master includes thermoplastic components. A heat-resistant intermediate pattern may be, for example, an electroformed metal replica of the compound pattern. Silicone and high-temperature epoxy replicas can also be used as intermediate patterns for vapor deposition. The silicone or epoxy replica can be formed upon a metal plate to ensure planarity and dimensional stability during the metal vapor deposition phase.

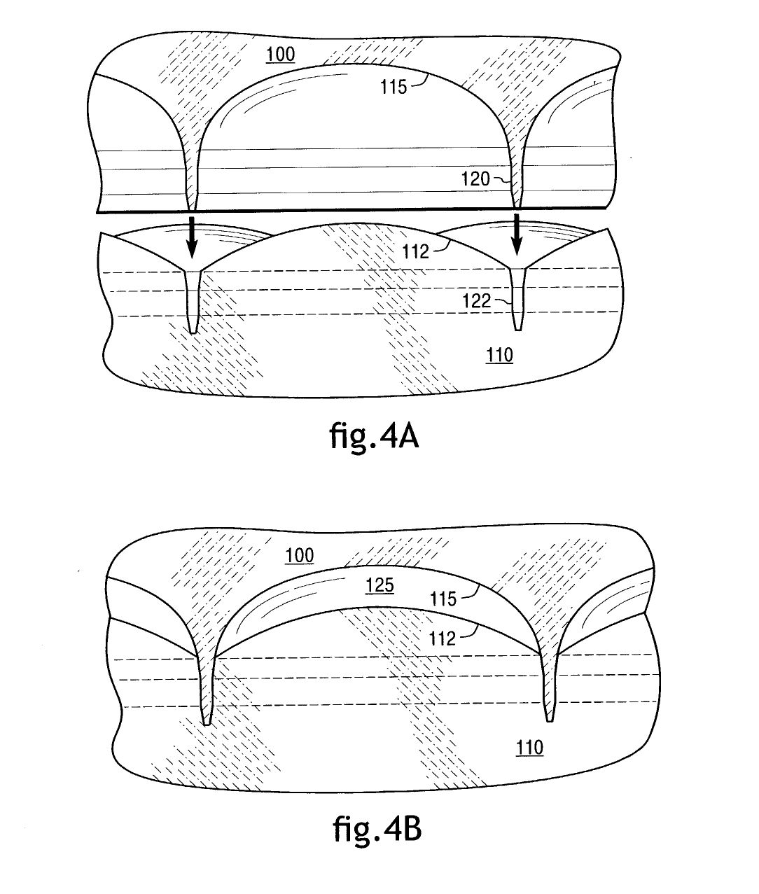

An advantage of the invention is that relatively complex tooling can be cost-effectively employed, since the tooling process need not be repeated for each relief structure. In another exemplary implementation, shown in FIG. 5, the relief structures 80 are polymeric microlens precursor mold pins formed in conjunction with a reflector precursor. When assembled, the compound master may be electroformed as a nickel mold face and used to produce multiple parts in optical-grade material. Once replicated in transparent material, each prism face becomes internally reflective, and diverts light at 90° to its axis of emission. The operation of this device is described in greater detail below.

FIG. 5 shows a preformed periscopic relief structure 150 having an aspheric aperture precursor 152 and reflector precursor 154. A square (or off-round) shaft 156 and a square guide taper 158 are fitted into corresponding holes 160 in a substrate 165. The bottom of the reflector precursor may act as an insertion stop. The insertion process is repeated until all available or appropriate holes are populated.

Square holes can be devised by exposure of a thick polymer resist material, such as SU-8, to UV light or other intense directional radiation through a patterned mask. The developed resist will have a deep relief corresponding to the transverse sectional pattern of the mask. In the present case, for example, square posts may be created in the resist. This polymeric relief is reproduced in metal, typically nickel or a nickel alloy, by electroforming. Because the electroforming leaves an irregular surface, the exposed surface is typically ground flat. Once the polymer is dissolved, a planar metal substrate having square holes 160 remains. Depending on the relative thicknesses of the resist and the electroform, the holes 160 can electively be blind holes or through-holes.

The relief-patterned substrate can alternately be fabricated in glass. Relief features can be created in vitreous material by mechanical or laser milling, ion milling, LIGA (a German acronym for X-ray lithography, electrodeposition, and molding), or through the use of a photosensitive glass. Etching processes have a particular advantage in that the process time is independent of the pattern shape and complexity. Square holes, or reliefs with other noncircular clocking shapes, can be devised. Noncircular clocking features are useful for positioning relief structures for prisms, reflectors, holders, and other aligned, radially asymmetric structures. The molding material for the relief structures may be thermoplastic polymer, thermosetting polymer, ceramic, glass, or metal.

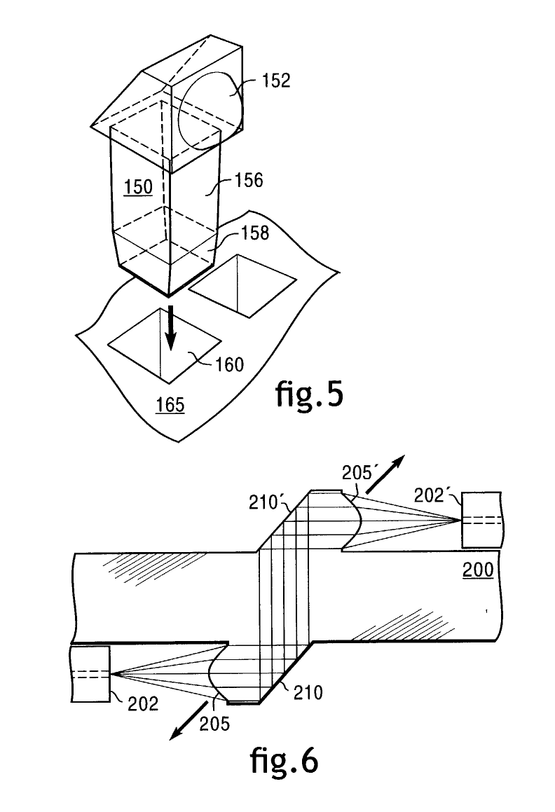

A metal electroform of the composite relief pattern is then derived. To separate the electroform from the assembled pattern, the electroform is generally parted along an oblique axis. The maximum slope of the lens surface should not exceed the angle of the reflector; in this example, the reflective surfaces are disposed at 45°, and the maximum slope at the rim of the aspheric aperture is under 45°, so the electroform may be parted from the pattern. The electroform can then be employed to repeatedly mold the surface. These molded replicas are extracted from a mold by similarly parting the mold along an oblique axis. The oblique axis of the relief structures 150 is indicated by the arrows in FIG. 6. This process yields surfaces with undercuts, but avoids the need for complex molds having three or more parts.

FIG. 6 illustrates the operation of a microoptical component having relief features 150 formed symmetrically on opposite planes of the monolithic part. As illustrated, the configuration shown may be used to efficiently couple optical fibers 202, 202′ occupying different planes. These optical fibers are converged/diverged by lens apertures 205, 205′ (formed from aperture precursor 152 shown in FIG. 5). Total internal reflection at reflectors 210, 210′ (corresponding to reflector precursor 154) allows transposition of a collimated beam between distinct optical planes. Such a microoptical component may include additional relief features for the positioning and alignment of the optical fibers.

Raised rather than recessed interfitting positioning features may be formed in a substrate. The positioning features therefore need not be holes, but may instead be elevated relative to the substrate, and may be, for example, cylindrical, pyramidal, conic or off-round in geometry. These features can be created, for example, by transfer of a relief patterned polymeric resist to a vitreous substrate by ion milling, or by replication of a surface having recessed relief features. Relief structures may have recesses that include sidewall geometries complementary to these raised features.

Reproduced relief structures can be metal, polymer, glass, rubber, elastomer, or any combination thereof. Reproduced parts can, for example, be thermoplastically molded, but may also be mechanically formed in a prefabricated sheet, or electroformed as conformal shells or screens. Relief-structure, substrate, and mold surfaces can be diversely treated to promote bonding or release as desired, as known to those skilled in the art. Holes in substrates may be, or may include, through-holes. Insertion or removal of relief structures may be assisted by pneumatic or mechanical force applied via through-holes. A relief structure may be used to form a pattern for a monolithic part, after which the monolithic part may itself be used as a relief structure in a secondary pattern of even greater complexity. Moreover, a relief structure may itself include a positioning feature for receiving a secondary relief structure thereon, facilitating greater contour complexity and/or overcoming limitations on obtainable intricacy that are inherent in the process (e.g., molding) by which the relief structures are fabricated.

Relief features in the substrate, such as tapered holes, may be formed in lands that are not coplanar with one another or with the primary surface plane of the substrate. Relief features in the substrate may also be formed in faces that are not parallel to the primary plane of the pattern. Holes may be sloped relative to the surface in which they are situated. Relief structures can be laid out in regular or irregular arrangements. Substrates may be curved in one or more axes.

It will therefore be seen that the foregoing represents a highly versatile approach to manufacture of complex surfaces. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A method of replicating a surface, the method comprising the steps of:
a. providing a rigid substrate having positioning features;
b. providing a plurality of relief structures each having a relief geometry and a positioning feature complementary to the substrate positioning features;
c. joining the relief structures to the substrate by mating the substrate positioning features and the relief-structure positioning features, thereby forming a relief master; and
d. replicating the relief master.

2. The method of claim 1 wherein the substrate positioning features are holes and the relief-structure positioning features are shafts received in the holes.

3. The method of claim 1 wherein the replicating step comprises:
a. fabricating a mold complementary to the relief master; and
b. using the mold to repetitively form surfaces corresponding to the relief master.

4. The method of claim 3 wherein the using step comprises casting from the mold.

5. The method of claim 3 wherein the using step comprises embossing with the mold.

6. The method of claim 3 wherein the using step comprises injection molding with the mold.

7. The method of claim 1 wherein the replicating step comprises:
a. fabricating a mold complementary to the relief master; and
b. using the mold to repetitively form surfaces corresponding to the relief master.

8. The method of claim 7 wherein the using step includes electroforming.

9. The method of claim 7 wherein the using step includes mechanical deformation.

10. The method of claim 1 wherein the feature elements are identical and produced by molding.

11. The method of claim 2 wherein the substrate positioning features are blind holes.

12. The method of claim 2 wherein the substrate positioning features are through-holes.

13. The method of claim 2 wherein the holes have sloping sidewalls.

14. The method of claim 1 wherein the wherein the substrate positioning features and the relief-structure positioning features are off-round to facilitate alignment of the relief structures with respect to the substrate.

15. The method of claim 1 wherein the joining step is preceded by a step of inducing dimensional disparity between the relief structures and the substrate by differential temperature-dependent expansion or contraction thereof.

16. The method of claim 1 wherein the joining step further comprises using an adhesive to retain the relief structures on the substrate.

17. The method of claim 1 wherein the joining step comprises friction-fitting the relief-structure positioning features with the substrate positioning features.

18. The method of claim 1 wherein the joining step is achieved using a pick-and-place insertion device.

19. A relief master comprising (a) a rigid substrate having positioning features and (b) a plurality of identical relief structures each having a relief geometry and a positioning feature complementary to the substrate positioning features, the relief structures being joined to the substrate and forming a surface pattern by mating of the substrate positioning features and the relief-structure positioning features.

20. The relief master of claim 19 wherein the substrate positioning features are holes and the relief-structure positioning features are shafts received in the holes.

21. The relief master of claim 19 wherein the substrate positioning features are blind holes.

22. The relief master of claim 19 wherein the substrate positioning features are through-holes.

23. The relief master of claim 20 wherein the holes have sloping sidewalls.

24. The relief master of claim 20 wherein the wherein the substrate positioning features and the relief-structure positioning features are off-round to facilitate alignment of the relief structures with respect to the substrate.

25. The relief master of claim 20 wherein the relief structures are retained on the substrate by an adhesive.

26. The relief master of claim 20 wherein the relief structures are retained on the substrate by friction.
